(19) United States
(12) Patent Application Publication
(10) Pub. No.: US 2014/0227672 A1
(43) Pub. Date: Aug. 14, 2014

(54) Memory aid

(71) Applicant: Robert Lionel Boucher, Overland Park, KS (US)

(72) Inventor: Robert Lionel Boucher, Overland Park, KS (US)

(21) Appl. No.: 13/815,209

(22) Filed: Feb. 11, 2013

(51) Int. Cl. G09B 19/00

(52) U.S. Cl. CPC G09B 19/00
USPC 434/319

(57) ABSTRACT

A device to be used as a memory aid. The device consists of a microphone (FIG. 1) wired to an amplifier (FIG. 2) wired to a speaker (FIG. 3). Sound from the speaker (FIG. 3) is aimed at and pressed against a person's skin (FIG. 3). Ear plugs or muffs shall be used to prevent sound from registering on the ear drums. A person will use this device while learning something new or while memorizing. A short period of adjustment will be required for the purpose of enhancing one's ability to make use of this device. With practice over a period of time the vibrations felt with sense of touch will come to be recognized as words. Once a user has adapted, the user will then be able to listen using his sense of touch which will enhance the users short term memory. The usual method of memorization includes reading, understanding, and listening. Using these three a person creates three ties to the brain for this new memory. To improve this a person adds the use of sense of touch which adds an additional tie to the brain. This additional tie may be stronger than the ties created by reading, listening, and understanding. All four used individually will most likely result in the maximum short term memory capability.

### OBJECTS AND ADVANTAGES

Accordingly there are objects and advantages of the present art:
(a) To improve one's short term memory and therefore their ability to learn new things.
(b) To improve one's ability to memorize new information.

### DRAWING FIGURES

FIG. 1 shows a parallelogram which represents a microphone. A wire represented by a line FIG. 1 is attached to the right side of said microphone and is strung to the right in the direction of FIG. 2. Said wire is attached electrically to said microphone.

FIG. 2 shows said wire from said microphone leading into the left side of a rectangle. The rectangle represents an amplifier. Another wire connected to the right side of said amplifier is strung off to the right in the direction of FIG. 3.

FIG. 3 shows said wire coming in from said amplifier in FIG. 2. Said wire electrically connects to a circle which represents a speaker. The said speaker shall be oriented such that its sound will be directed into the human body. Said speaker will also be set up to press against the human body. Said speaker is shown pressing into the stomach. Also ear muffs are shown over the subjects ears to prevent hearing.

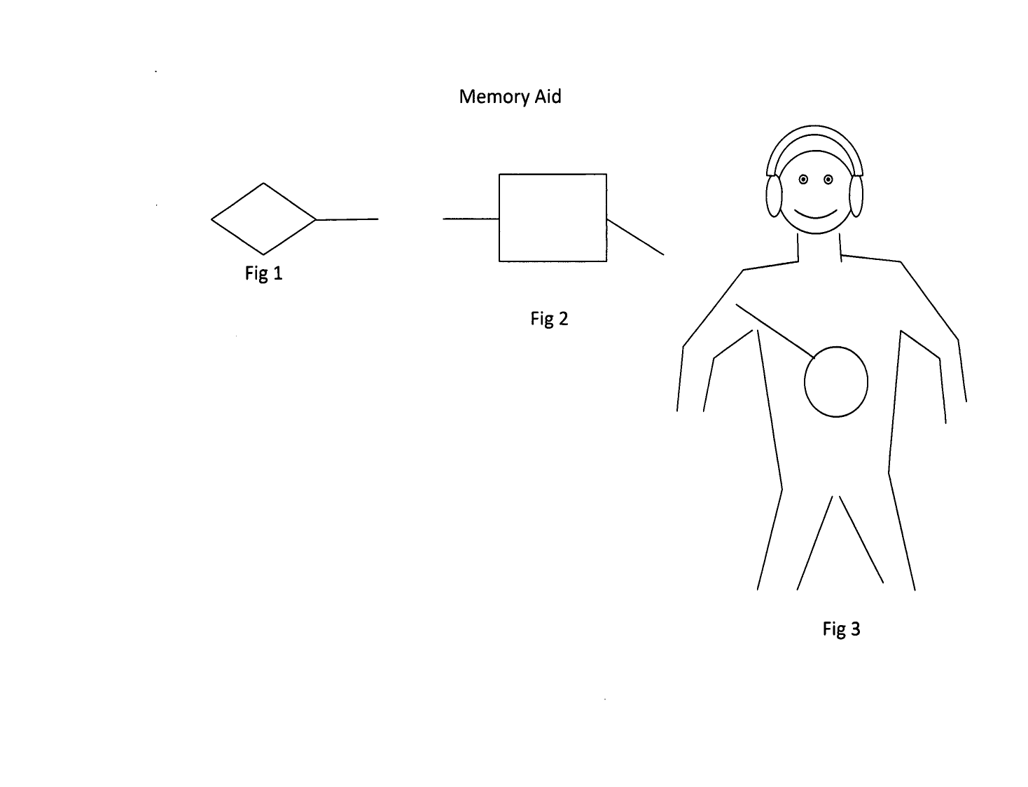

### DESCRIPTION OF INVENTION

In FIG. 3 said speaker is pressed against the stomach such that said speaker's moving parts that create the sound waves makes intimate contact with skin. Instead of the stomach as the point of contact the user could press his finger tips against the speaker material. The movement of said speaker material can be felt by nerve endings in the skin. A speaker selected for this use should allow for intimate contact with the skin. Speaker material should be capable of transmitting its sound vibrations while in contact with the human body without significant loss of vibrations. Finger tips may provide the most sensitivity and minimally diminish the movement of the speaker material and therefore be the most effective. In addition the ears need to be plugged to force the user to use only his sense of touch to listen.

The user's brain will need time to develop the ability to interpret the said vibrations. Each human sense (i.e. hearing, sight, touch, smell) is interpreted by its own unique and exclusive part of the brain. A part of the brain used to manage sense of touch information normally has experienced interpreting minimally challenging things such as how fabric feels, how skin feels and hair feels etc. Upon first use of this invention the touch sensory part of one's brain may not have the capacity to interpret the said vibrations representing 450,000 English words. These vibrations may feel meaningless. With practice the user will be able to understand all words through sense of touch.

### SUMMARY

In essence this device is a short term memory enhancement device to be used to more quickly memorize new information. It will work with the human sense of touch to deliver the spoken work to the users brain. Since short term memory is enhanced with each additional tie to the brain and since each human sense has its own unique connection to the brain adding sense of touch will improve short term memory by 30 percent or more.

The system consists of ear plugs to plug the ears. A microphone, amplifier, and speaker, to pick up the sounds and allow one to apply the vibrations directly to the skin and therefore use sense of touch for hearing and memorization. A period of learning and adjustment may be needed to develop the ability to interpret these vibrations and make distinctions between all words. Over time the user will learn and adapt. Those with Attention Deficit Disorder may find this idea especially useful since they may at time struggle more with memorization.

The design and construction of this invention isn't critical. A microphone electrically connected to an amplifier which is in turn electrically connected to a standard speaker. A person puts their fingers on the speaker and feels the vibrations. What is critical is the patience and perseverance the user needs to have to give his brain time to enhance itself so he can begin to understand the vibrations. It is also a matter of giving the sense of touch portion of the brain time to grow in size and strengthen itself. Physical changes will occur with constant trying. Just as a blind person's hearing is significantly more,powerful than the hearing of people with sight. A person's sense of touch will become capable of interpreting how words feel using this invention.

### CONCLUSIONS, RAMIFICATIONS, AND SCOPE OF INVENTION

Although the description contains many specificities, these should not be construed as limiting the scope of the invention but as merely providing illustrations of some of the presently observed embodiments of this invention. For example the system's microphone and amplifier could be replaced by a stereo, iPod, tape or CD player. This invention is about the use of the sense of touch for short term memory improvement nothing more.

Thus the scope of this invention should be determined by the claims and their legal equivalents, rather than by the examples given.

I claim:

1. A memory aid for all those wishing to learn faster comprising:
a. A sound receiving device or microphone to receive sounds, convert them to an electrical signal and transmit the said signal.
b. A signal amplifying device or amplifier to ensure adequate vibrations are attained.
c. A signal interpretation device or speaker to recreate the said vibrations.
d. A means of connecting said devices together and connecting said speaker to the skin to cause the nerves in the skin to feel the said sound.
